(19) United States
(12) Patent Application Publication
(10) Pub. No.: US 2022/0218096 A1
(43) Pub. Date: Jul. 14, 2022

(54) GRILL BRUSH WITH ROTATABLE GRATE-CLEANING IMPLEMENT PLATE

(71) Applicant: Creative Hat, Inc., Springfield, MA (US)

(72) Inventors: Mario E. Magnani, Springfield, MA (US); Andrew Jones, Roslindale, MA (US); Richard L. Miller, Needham, MA (US); David Walsh, Reading, MA (US); Ryan J. Waters, Boston, MA (US); Brian Yoo, Arlington, MA (US)

(21) Appl. No.: 17/538,696

(22) Filed: Nov. 30, 2021

Related U.S. Application Data
(60) Provisional application No. 63/119,020, filed on Nov. 30, 2020.

(51) Int. Cl. A46B 15/00; A47J 37/07; A46B 5/02; A46B 9/02; A46B 7/04

(52) U.S. Cl. CPC A46B 15/0081; A47J 37/0786; A46B 7/04; A46B 9/02; A46B 5/02

(57) ABSTRACT

A grill brush includes a brush head with brush-head upper and lower surfaces, the brush-head lower surface having a plurality of bristles protruding therefrom. An elongated handle extends between handle proximate and distal ends. The handle distal end is defined in part by a brush-head mount including a mounting surface configured to retain the brush-head upper surface. A grill-cleaning implement plate is situated at least partially between the brush-head upper surface and the brush-head mount and extends longitudinally between plate back and front ends. At least one of the plate back and front ends has depending therefrom a grate-cleaning implement. The implement plate is rotatably retained between the brush-head upper surface and the brush-head mount such that, with the brush head stationary relative to the brush handle, the implement plate can be rotated with respect to the brush handle and brush head between mutually opposed first and second angular orientations.

### PROVISIONAL PRIORITY CLAIM

Priority based on Provisional Application Ser. No. 63/119,020 filed Nov. 30, 2020, and titled “GRILL BRUSH WITH ROTATABLE GRATE-CLEANING IMPLEMENT PLATE” is claimed. Moreover, the entirety of the previous provisional application, including the drawings, is incorporated herein by reference as if set forth fully in the present application.

### BACKGROUND

Numerous, variously-configured implements for cleaning cooking grills exist. These implements typically take the form of brushes, scrapers, or some combination of a brush and scraper. A basic configuration of a brush with a scraper includes a handle with a distal end having a lower side from which protrudes a plurality of bristles and an upper side to which there is affixed a scraper blade. One issue with this traditional configuration is that the bristles wear out long before the handle or scraper blade do. Moreover, it is usually the forwardmost bristles that wear first, while more rearward bristles remain perfectly serviceable. As a result, brushes are frequently discarded—handle and all—after the forwardmost bristles are worn, but with the bristles located nearest the handle, and well as the scraper, still in near-new condition.

Additionally, grill brushes conforming to the basic configuration do not permit the bristles to reach the full lengths of the grill-grate bars, for example, before the scraping edge of the scraping blade contacts the side of the firebox, thereby limiting access by the bristles to surfaces to be cleaned. Conversely, in some designs, full access to surfaces by the scraper is impeded by the bristles of the brush portion contacting surfaces of the cooking grill. A still-additional limitation of a traditional grill brush is that, at least in normal use, the scraper is immovably affixed to the upper side, and has a single usable end with limited functionally.

Accordingly, a need exists for a grill brush with a replaceable or reversible brush head and a grill-cleaning implement plate that includes a scraper on one end and is rotatable in order to (a) move the scraper out of the way so that the brush bristles can access more surfaces or (b) deploy disparate grill-cleaning implements situated on an end of the implement plate opposite the scraper, thereby enhancing the functionality of the grill brush.

### SUMMARY

In a first embodiment generally illustrative of the invention, a grill brush includes a brush head and a brush handle cooperatively configured such that the brush handle can is selectively capture and retain the brush head. The brush head includes a brush-head block defining brush-head upper and lower surfaces extending longitudinally along a brush-head axis between brush-head rear and forward ends, and laterally opposed brush-head left and right sides extending between the brush-head upper and lower surfaces and longitudinally between the brush-head rear and forward ends. The brush head further includes at least one bristle array defined by a plurality of bristles protruding from the brush-head lower surface, each of the bristles terminating in a bristle tip for engaging a work surface.

The brush handle includes a grip portion which, in each of various versions, is configured for grasping by a human hand. Integral with or otherwise depending from the grip portion is a brush-head mount by which the brush head can be selectively captured and retained. The brush handle has a lengthwise extent disposed generally along a handle axis between handle proximate and distal ends.

The brush-head mount at least partially defines the handle distal end and includes a mounting surface. The mounting surface and the brush-head upper surface are cooperatively configured such that (i) the brush handle can selectively capture and removably retain the brush head and (ii) when the brush head is retained by the handle, there is defined an attachment plane between the mounting surface and the brush-head upper surface.

Situated at least partially between the brush-head upper surface and the brush-head mount is a grill-cleaning implement plate, which may be alternatively and interchangeably referred to as “implement plate” or simply “plate.” The implement plate extends longitudinally along the attachment plane between plate back and front ends. At least one of the plate back and front ends has depending therefrom at least one grate-cleaning implement. In one version, for example, the plate front end terminates at and defines a scraper blade pitched at a blade angle relative to the attachment plane such that a scraping edge of the scraper blade is situated at least one of (a) above and (b) forward of the brush-head block. Grate-cleaning implements alternative to a scraper blade are considered later in the summary and detailed description, but are not, in any event, considered a limiting feature of various embodiments.

The plate is an element separate (i.e., distinct) from both the handle and the brush head. Accordingly, when the brush head is selectively removed from the handle, the plate is freed—or can be freed—from between the brush-head upper surface and the brush-head mount, thereby enabling replacement of the plate. Most commonly, when the plate includes a scraper, the plate and scraper are part of the same unitary structure. For this reason, a plate having an associated integral scraper may, when applicable, be referred to alternatively as a “scraper plate” in the specification and/or the claims, most especially when the implement plate defines, includes, or carries no implement other than a scraper.

According to one version, the implement plate is retained as part of the assembled grill brush in part by virtue of being interposed (sandwiched) between the brush-head upper surface and the mounting surface of the brush-head mount.

Moreover, with the brush head fixed (i.e., immovably retained) relative to the brush handle, the plate can be rotated about a plate-rotation axis between mutually opposed first and second angular orientations. Relative to the brush handle, the first angular orientation is such that the plate front end is situated forward of the plate rear end, while the second angular orientation is such that the plate front end is situated rearward of the plate rear end. The plate front and rear ends are on opposite sides of the plate-rotation axis. The plate can be selectively locked in at least each of the first and second angular orientations by various alternative mechanisms, illustrative, non-limiting examples of which are later described in the detailed description.

In displacing the plate between the first and second angular orientations, the plate rotates—while retained between the brush handle and brush head—along a plate rotation plane relative to which the plate-rotation axis extends orthogonally. The plate rotation plane is one of (i) parallel to and (ii) identical with the attachment plane. In each of various embodiments, the rotatability of the plate serves purposes later explained.

As described, the plate rotates between the brush-head mount of the brush handle and the brush-head upper surface, while the brush head is stationary relative to the handle. In various embodiments, the brush head is retained to the handle by a brush-head fastener centrally located along the plate-rotation axis. However, in order to prevent the rotation of the brush head relative to the handle as the plate is rotated, there is provided at least one off-center lug that mechanically connects, and creates mechanical interference between, the brush-head mount and the brush head. Illustratively, the lug is in the form of a pin or rod that extends into and between each of the brush-head mount and the brush-head block. Alternatively, the lug could be integrally formed with one of the brush-head mount and the brush-head block and be selectively received into a lug-receiving recess defined in the other of the brush-head block and the brush-head mount. Regardless of the lug configuration, it is important to various implementations that the lug(s) and lug-receiving recess(es) facilitate selective separation of the brush head from the brush-head mount. Removability of the brush head facilities replacement of worn brush heads, installation of disparate brush heads for different cleaning and/or surface-preparation functions, and/or reversal of a brush head on the brush-head mount.

In addition to being off center of the plate-rotation axis, the lug extends through the plate. In order to facilitate plate rotation unimpeded by the off-center lug, there is defined through the implement plate of one embodiment an arcuate lug slot centered about the rotation axis. As the plate is rotated, the off-center lug travels within the arcuate lug slot. Desirably, the arcuate lug slot defines a circular arc that subtends an angle sufficiently large to accommodate plate rotation of at least 180°. In this way, the plate can be alternatively positioned into first and second angular orientations that are 180° in opposition.

According to one version, the implement plate front end terminates at and defines a scraper blade pitched at a non-zero blade angle relative to the attachment plane such that a scraping edge of the scraper blade is situated at least one of (a) is above and (b) forward of the brush-head block. Additionally, however, the plate back end carries a plurality of grill-grate-abrading elements, such as tines. Each of the tines includes a tine base by which it is retained by the plate back end and from which extends a tine shank terminating in a tine tip opposite the tine base. Moreover, each tine is pitched at a tine angle relative to the attachment plane such that the tine tip is situated at least one of (a) above and (b) rearward of the brush-head block.

The rotation of an implement plate configured as described above about the plate-rotation axis changes the relative positons of the scraper blade and the tines in order to facilitate their use is different grill cleaning functions. More specifically, when the plate is in the first angular orientation, the scraper blade is situated forward of the tines. Conversely, when the plate is in the second angular orientation, the tines are situated forward of the scraper blade. Relative to each of the scraper blade and the tines, the angular orientation in which it/they are forward of the other is regarded as the “deployed orientation.” In order to use either the scraper blade or tines in the deployed orientation to engage a grill surface to be cleaned, the brush handle is inverted such that the brush head is above the plate. For purposes of consistent spatial and directional orientation, unless otherwise noted, the relative terms “rearward of” and “forward of” are defined with respect to a user of the grill brush but also, in more “self-contained” and universally applicable terms, with reference to the handle proximate end, which is always regarded as rearward of the brush head, irrespective of how a user is grasping the grill brush at any given time, or if anyone is holding it at all.

The scraper can be used to scrape grease, burned food, and other debris from the top surfaces of the mutually parallel bars of a grill grate (hereinafter, “grill-grate bars”), as well as other surfaces within the firebox of a grill. The tines, on the other hand, can be deployed to access and remove debris from the sides of the grill-grate bars, areas that would otherwise be inaccessible. Spacing between adjacent tines accommodates a grill-grate bar in order to facilitate engagement of each tine with the sides of adjacent grill-grate bars.

In some variants, each tine further comprises tine bristles. More specifically, in one configuration, a rigid tine shank extends along and defines a tine-shank axis that extends from the tine base to the tine tip. The tine bristles depend from the tine shank and extend outwardly therefrom with components of spatial extension perpendicular to the tine-shank axis. In one specific version, the rigid tine shanks are in the form of twisted wire in which two runs of wire are arranged side-by-side and twisted in order to form a double-helix that extends along the tine-shank axis. The two “runs” of stiff wire can be formed from a single wire folded over into “hairpin” configuration before twisting. During the fabrication process, and before the two parallel runs of wire (wire rod) are twisted to form the double helix, thinner and shorter wire strands are placed therebetween in an orientation generally perpendicular to the wire rods. The twisting of the larger wire rods forming the helix clamps down on the small wires and traps them between the twisted wire runs. These shorter and thinner wires constitute the bristles. Twisted wire brushes are already known in the art, thereby obviating the need for more in-depth explanation. When the tines are of the general configuration described above, they may be alternatively and interchangeable referred to as “bore brushes.” In other words, for the purposes of the present specification and claims, a “bore brush” is regarded as a sub-category of “tine.”

Among alternative embodiments, the brush head includes bristles varying in length, thickness, coarseness, and material, for example. Bristle arrays comprising bristles of disparate types, sizes, and materials facilitate use of brushes of the general type disclosed in a broader scope of applications, from general cleaning and scrubbing of surfaces, to surface preparation for painting, to cleaning the grates of cooking grills. Accordingly, while the brushes disclosed and described herein are generally presented as “grill brushes,” it is to be understood that this is the principal context that inspired their conception, and that, absent explicit claim limitations, this designation is not intended to expressly or impliedly limit the application of brushes defined within the scope of the claims, their designation as “grill brushes” notwithstanding.

Alternative embodiments may manifest in the form of brush kits, each of which kits is comprised of at least one brush handle that accepts a variety of brush heads. The brush heads could vary in shape, size, bristle-type, bristle-array configuration, and bristle material, for example. It is envisioned that a handle could be retained and, when brush heads wear out, or different brush heads and bristle types are required, additional brush heads compatible with the handle could be purchased as replacements and/or additions to a brush owner's existing array of brush heads.

In a broad aspect, the implement plate could be rotated by direct contact between a user's fingers and the plate. However, each of various embodiments includes a rotary dial that (i) is carried by and within the brush-head mount of the handle and (ii) facilitates plate rotation from above the brush-head mount (i.e., from the side of the brush-head mount opposite the side of the brush-head mount to which the brush head is attached).

The rotary dial has dial upper and lower surfaces, the upper surface being accessible to fingers of a user from above the brush-head mount. The rotary dial is rotatable within a dial-retaining channel defined within the brush-head mount. Mechanical engagement between the rotary dial and the implement plate facilitates the rotation of the implement plate between the mutually opposed first and second angular orientations previously described. The rotary dial is rotatable about a dial-rotation axis that coincides with the plate-rotation axis.

According to a first illustrative embodiment including a rotary dial, in addition to rotational displacement, the dial-retaining channel accommodates the linear displacement—along the dial-rotation axis—of the rotary dial “upward” and “downward” respectively away from and toward the brush head situated below the brush-head mount. The rotary dial carries a lock protuberance that, in various configurations, serves dual purposes. A first purpose is to retain the rotary dial within the brush-head mount by extending under an annular inner step defined within dial-retaining channel. As the rotary dial is rotated within the dial-retaining channel, the lock protuberance rides along the annular inner step, thereby retaining the rotary dial within the dial-retaining channel. A second purpose of the lock protuberance relates to defining “locked” or “set” positions of the rotary dial corresponding to the first and second angular orientations of the implement plate.

The brush-head mount has defined therein at least first and second protuberance-receiving recesses diametrically opposed on opposite sides of the plate-rotation and dial-rotation axes. In one embodiment, the first and second protuberance-receiving recesses are defined along the annular inner step that engages with the lock protuberance to retain the rotary dial within the dial-retaining channel. A “locked” position of the rotary dial is an “upward” position thereof in which the lock protuberance is received within one of the first and second protuberance-receiving recesses. In a locked position, the lock protuberance is mechanically engaged (e.g., in an interference fit) with one of the first and second protuberance-receiving recesses in order to prevent—or at least provide resistance against—unintentional rotation of the rotary dial. Conversely, an unlocked position of the rotary dial is a “downward” position in which the lock protuberance is mechanically disengaged from both of the first and second protuberance-receiving recesses in order to permit desired rotation of the rotary dial. The rotary dial is mechanically linked to the implement plate such that, as the rotary dial is rotated about the dial-rotation axis, the implement plate rotates in unison therewith about the plate-rotation axis.

In the first illustrative embodiment, the rotary dial is normally biased upward toward a locked position. “Normally” in this context denotes “usually” or “by default,” and not orthogonally. The mechanical biasing action is provided by a biasing member. Illustratively, the biasing member is a coiled spring carried within the brush-head mount and helically disposed about the plate-rotation and dial-rotation axes. The biasing member acts to mechanically bias the rotary dial upwardly from below the rotary dial upper surface. In order to rotate the plate, a user depresses the rotary dial downwardly into the dial-retaining channel and rotates it until the desired plate orientation is achieved.

Depending on the specific configuration of the lock protuberance and the protuberance-receiving recesses, a user might not actually need to actively push down on the dial in order to cause it to depress into the dial-retaining channel of the brush-head mount. Instead, user-applied torque of sufficient magnitude will cause the lock protuberance to mechanically disengage from a protuberance-receiving recess, thereby reducing the resistance to dial rotation. As the rotary dial is rotated, and the lock protuberance rides along the annular inner step, the lock protuberance will eventually arrive at, and mechanically engage with (“pop into”) the opposing protuberance-receiving recess, thereby “locking” the plate into the position opposite that from where it began.

In a second illustrative embodiment including a rotary dial, the rotary dial does not linearly displace “upwardly′ and “downwardly” along the dial-rotation axis. Instead, the rotary dial includes a generally cylindrical barrel defined by a dial side wall. The cylindrical barrel is configured to rotate within a cylindrical dial-retaining channel defined within the brush-head mount. The dial side wall includes at least one peripheral protrusion configured to selectively mechanically interfere with opposed recesses defined within the dial-retaining channel. The peripheral protrusion is carried by a flexible element that provides a restorative force to mechanically bias the protrusion into engagement (i.e., mechanical interference) with the recesses of the dial-retaining channel. Because the protrusion is carried on the periphery of the rotary dial, axial displacement of the rotary dial is unnecessary to lock and unlock the rotary dial and implement plate in opposed first and second angular orientations. Details of the rotary dial associated with the second illustrative embodiment are presented in the detailed description.

As previously explained relative to an illustrative embodiment, the brush head is retained to the handle by a brush-head fastener centrally located along the plate-rotation axis. Illustratively, the brush-head fastener is an externally threaded fastener with a keyed head that facilitates rotation thereof by a complementarily-keyed tool such as a screwdriver or hex key. In each of various configurations, the brush-head fastener is held captive within a brush-head fastener channel defined within the brush-head mount. Moreover, the brush-head fastener is accessible from above the brush-head mount to enable selective detachment for the brush head from the brush-head mount. Accordingly, in an embodiment including a rotary dial configured as generally described above, the rotary dial includes a fastener-access channel extending therethrough along the dial-rotation axis. The fastener-access channel facilitates insertion of a tool (e.g., screwdriver or hex key) through the rotary dial and down into the brush-head fastener channel so that a user can selectively thread the brush-head fastener into or out of an internally-threaded fastener hole defined through the brush-head upper surface.

Representative embodiments are more completely described and depicted in the following detailed description and the accompanying drawings.

### BRIEF DESCRIPTION OF THE DRAWINGS

FIG. 1 is a left-side elevation view of a grill brush according to a first illustrative embodiment including a brush head, a brush handle, and grate-cleaning implement plate interposed between the brush head and handle, wherein the brush head is angularly fixed (i.e., not configured for rotation) relative to the brush handle, while the plate is retained for rotation relative to both the handle and the brush head;

FIG. 2 is a cross-sectional view of the grill brush depicted in FIG. 1 with an alternative plate configuration;

FIG. 3 is a partially exploded view of the grill brush shown in FIGS. 1 and 2 with the plate configuration of FIG. 2;

FIG. 4 is a fully exploded view of the brush handle assembly of the grill brush in FIGS. 1-3 depicting the internal mechanisms for selectively rotating the implement plate;

FIG. 5 is a bottom view showing the brush-head mount portion of the brush handle of FIGS. 4 and 5 with a plate-rotating rotary dial installed;

FIG. 5A shows an enlargement of the rotary dial of FIG. 5 in isolation, but in the same orientation in in which the rotary dial is depicted in FIG. 5;

FIG. 6 depicts a grill-cleaning implement plate in isolation;

FIG. 7 shows an alternatively configured grill brush according to a second illustrative embodiment having a grill-cleaning implement plate that—like the embodiment of FIGS. 1-6—is rotatable relative to the brush handle between first and second angular orientations into which it can be selectively retained or “locked,” but with a simplified set of mechanisms relative thereto;

FIG. 8 is a cross-sectional view of the grill brush shown in FIG. 7; and

FIG. 9 is a partially exploded cross-sectional view of the embodiment of FIGS. 7 and 8;

FIG. 10 is a top perspective view of the brush head of the embodiment of FIGS. 7-9 shown in isolation;

FIG. 11 is a top perspective view of the brush head of FIG. 10 in which a grill-cleaning implement plate has been set thereon for rotation relative to the brush head;

FIG. 12 shows the rotary dial and a top view of a portion of the handle associated with the second embodiment including a brush-head mount into which the rotary is configured to be seat for rotation; and

FIG. 13 depicts how tines carried by the implement plate of the second embodiment engage the bars of a grill grate to remove debris therefrom.

### DETAILED DESCRIPTION

The following description of variously configured grill brushes and grill brush systems is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims.

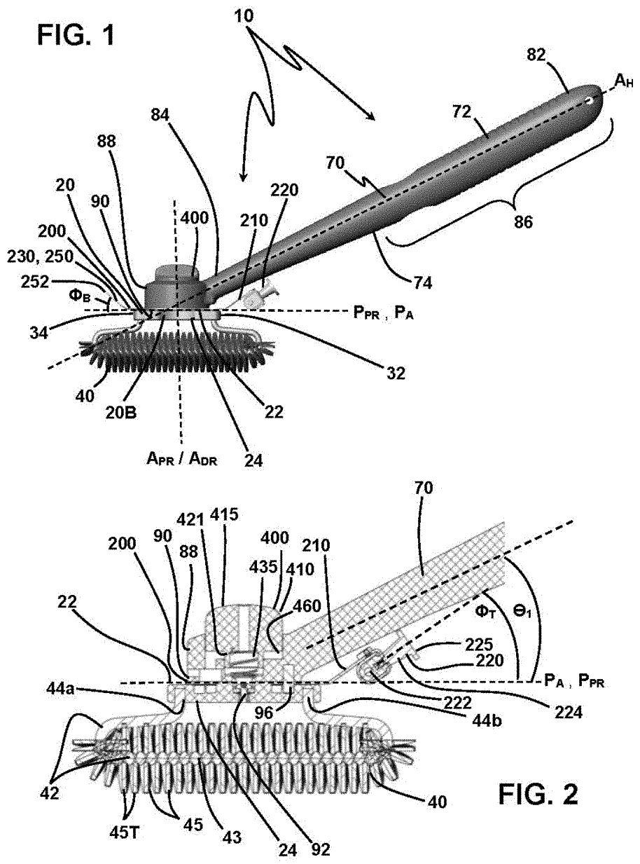

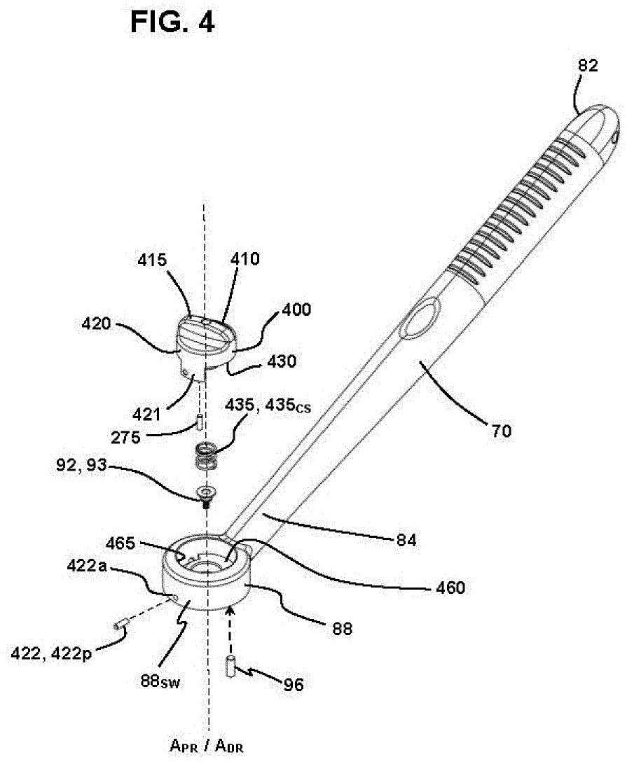

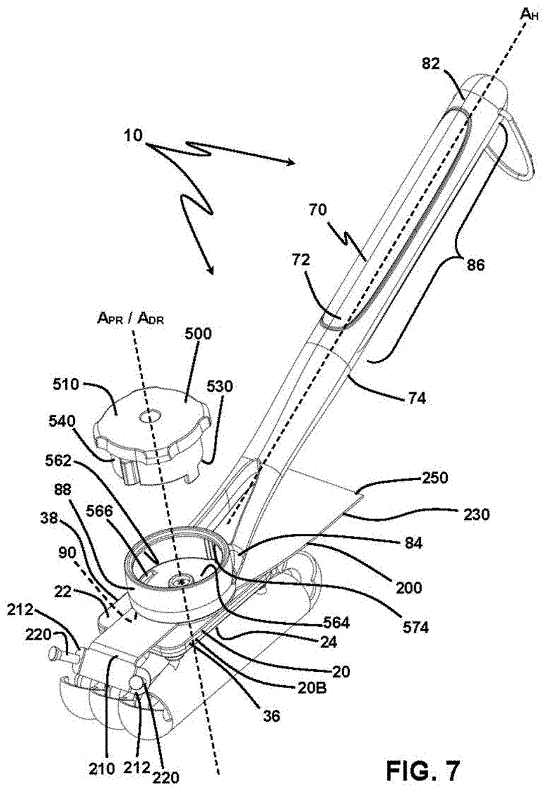

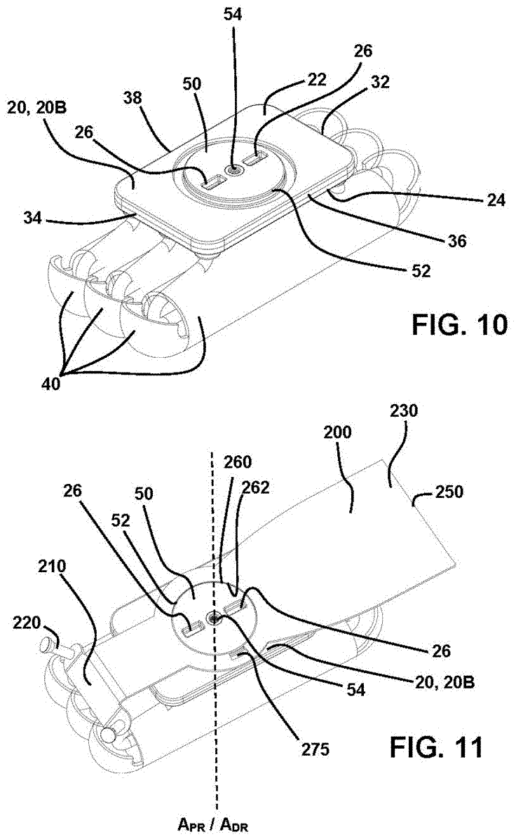

Shown in the included drawings are various views and illustrative versions of grill brushes generally identified by the reference number 10. The invention is explained in the context of two main illustrative embodiments, each of which includes illustrative variations in its subcomponents and specific functionalities. A main first embodiment is holistically described initially with general reference to FIGS. 1-3, while FIGS. 4-6 variously depict subcomponents of the grill brush 10 of FIGS. 1-3. A main second embodiment is holistically described initially with general reference to FIGS. 7-9, while subcomponents specific to it are depicted in, and described with principal reference to, FIGS. 10-13. The main first and second embodiments have several basic components and features in common. Accordingly, for purposes of efficiency, the early portions of the detailed description are written in a way that applies to both main embodiments, except where expressly noted, while later portions of the detailed description, labeled with their own sub-headings, are dedicated to describing aspects that differentiate each of the two main embodiments from the other. As will be appreciated more fully later in the description, the two main embodiments differ most significantly in very particular mechanical elements for facilitating rotation of a grill-cleaning implement plate.

While early portions of the detailed description are largely applicable to the two main embodiments, the description frequently refers to the two embodiments in the singular. For example, reference may be made to “the grill brush 10” in a manner intended to refer to each of the two main embodiments simultaneously when the description is equally applicable to both. Moreover, for the sake of efficiency and descriptive clarity, illustrative, non-limiting additions, optional features, and alternative configurations of various elements relative to a main embodiment are described with conjunctive reference to that main embodiment. Additionally, throughout the specification and drawings, like elements across alternative embodiments are referenced by similar or identical numeric and/or alphanumeric reference characters.

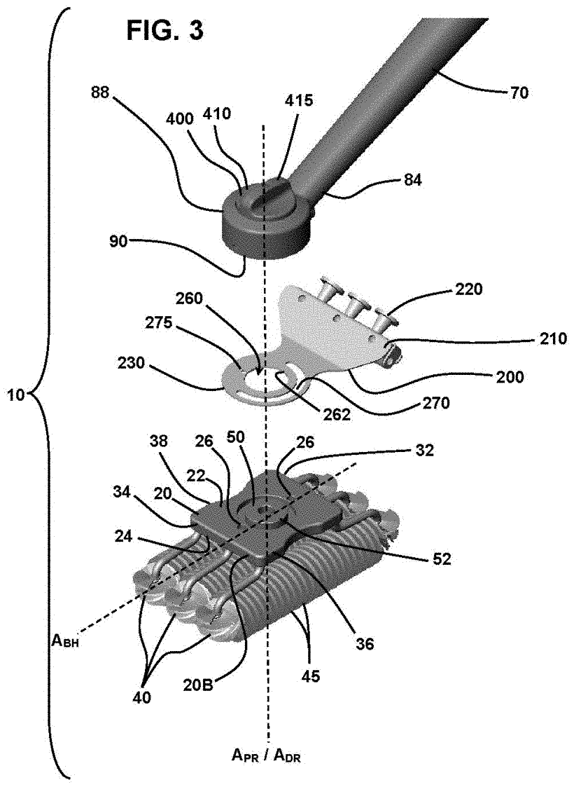

With initial reference to the assembled view of FIG. 1 and the exploded view of FIG. 3 of the first embodiment, and FIGS. 7-9 of the second embodiment, a bristle-retaining brush head 20 (alternatively referred to as “brush head 20”) includes a brush-head block 20B having brush-head upper and lower surfaces 22 and 24 extending longitudinally along a brush-head axis A_{BH} between brush-head rear and forward ends 32 and 34. Additionally, extending between the brush-head upper and lower surfaces 22 and 24, and longitudinally along the brush-head axis A_{BH} between brush-head rear and forward ends 32 and 34 are laterally opposed brush-head left and right sides 36 and 38. The initial designations of the brush-head rear and forward ends 32 and 34 is, of course, entirely arbitrary, particularly in embodiments, such as the ones depicted, that are symmetrical about a center plane (not shown) when viewed from either of the brush-head left and right sides 36 and 38.

With continued reference to FIGS. 1 and 3, and additional reference to the cross-sectional view of FIG. 2, as well as FIGS. 7-9, the illustrative grill brush 10 further includes a brush handle 70 having brush-handle top and bottom surfaces 72 and 74 which, while contoured, have a lengthwise extent disposed generally along a handle axis A_{H} between handle proximate and distal ends 82 and 84. The brush handle 70 further includes a grip portion 86 configured for grasping by a human hand. Integral with or otherwise depending from the grip portion 86 is a brush-head mount 88 by which the brush head 20 can be selectively captured and retained.

The brush-head mount 88 at least partially defines the handle distal end 84 and includes a mounting surface 90. The mounting surface 90 and the brush-head upper surface 22 are cooperatively configured such that (i) the brush handle 70 can selectively capture and removably retain the brush head 20 and (ii) when the brush head 20 is retained by the brush handle 70, there is defined an attachment plane P_{A} between the mounting surface 90 and the brush-head upper surface 22. The handle axis A_{H} is pitched at a first angle θ₁ relative to the attachment plane P_{A}.

Retained by the brush head 20, and depending from the brush-head lower surface 24 thereof, is at least one bristle array 40 comprising a plurality of bristles 45, each of which bristles 45 terminates in a bristle tip 45T configured for engaging a work surface. Among alternative versions, the bristle array(s) 40 may be disparately configured. In the version of FIGS. 1-3 presently under consideration, and as shown most clearly in FIG. 2, each of three bristle arrays 40 comprises a rigid spine 42 from which radially extend a plurality of bristles 45. In this version, each rigid spine 42 comprises twisted wire. Each twisted wire spine 42 has a main or central spine portion 43 that extends between spine first and second ends 44a and 44b. Although the bristle arrays 40 and bristles 45 associated with the second embodiment may be configured similarly to those of the first embodiment, in most instances, only the general contours of the bristle arrays 40 are shown relative to the second embodiment in order to render the figures clear for lead lines leading to more central components of the grill brush 10. Accordingly, the more detailed illustrations of bristles 45 and bristles arrays 40 shown in FIGS. 1-3 are relied upon and referred to as support for the same or similar types of bristles 45 and bristle arrays 40 in the second embodiment.

Similar to the twisted wire tines described in the summary, in one illustrative version, each twisted wire spine 42 is fabricated from two runs of wire arranged side-by-side and twisted in order to form a double-helix. The two “runs” of stiff wire can be formed from a single wire folded over into “hairpin” configuration before twisting. During the fabrication process, and before the two parallel runs of wire (wire rod) are twisted to form the double helix, thinner and shorter wire strands are placed therebetween in an orientation generally perpendicular to the wire rods. The twisting of the larger wire rods forming the helix clamps down on the small wires and traps them between the twisted wire runs. These shorter and thinner wires constitute the bristles 45.

Beyond the relatively straight central spine portion 43, each spine first and second end 44a and 44b is contoured to extend substantially orthogonally to the central spine portion 43. Each of the spine first and second ends 44a and 44b is fixedly secured to the brush-head block 20B. Illustratively, the brush-head block 20B is formed of plastic, and the spine first and second ends 44a and 44b are inserted into the plastic before the plastic hardens during fabrication. The brush head(s) 20 shown are, of course, entirely illustrative and non-limiting; their precise configuration is not central to the present invention.

Situated at least partially between the brush-head upper surface 22 and the mounting surface 90 of the brush-head mount 88 is a grill-cleaning implement plate 200 which, as indicated in the summary, may be interchangeably referred to as “implement plate 200” or “plate 200.” The implement plate 200 extends longitudinally along the attachment plane P_{A} between plate back and front ends 210 and 230. In FIGS. 1-3, two disparate plates are depicted. In the version of the first embodiment shown in FIG. 1, the plate front end 230 terminates at and defines a scraper blade 250 pitched at a non-zero blade angle ϕ_{B} relative to the attachment plane P_{A} such that a scraping edge 252 of the scraper blade 250 is situated at least one of (a) above and (b) forward of the brush-head block 20B.

In the version of FIGS. 2 and 3, only the plate back end 210 carries grill-cleaning implements, and these implements are of the same type carried by the plate back end 210 in the version of the plate depicted in FIG. 1. More specifically, the plate back end 210 carries a plurality of grill-grate-abrading tines 220, hereinafter alternatively referred to as tines 220. Each tine 220 includes a tine base 222 by which it is retained by the plate back end 210, and from which extends a tine shank 224 terminating in a tine tip 225 opposite the tine base 222. Moreover, each tine 220 is pitched at a tine angle ϕ_{T} relative to the attachment plane P_{A} such that the tine tip 225 is situated at least one of (a) above and (b) rearward of the brush-head block 20B.

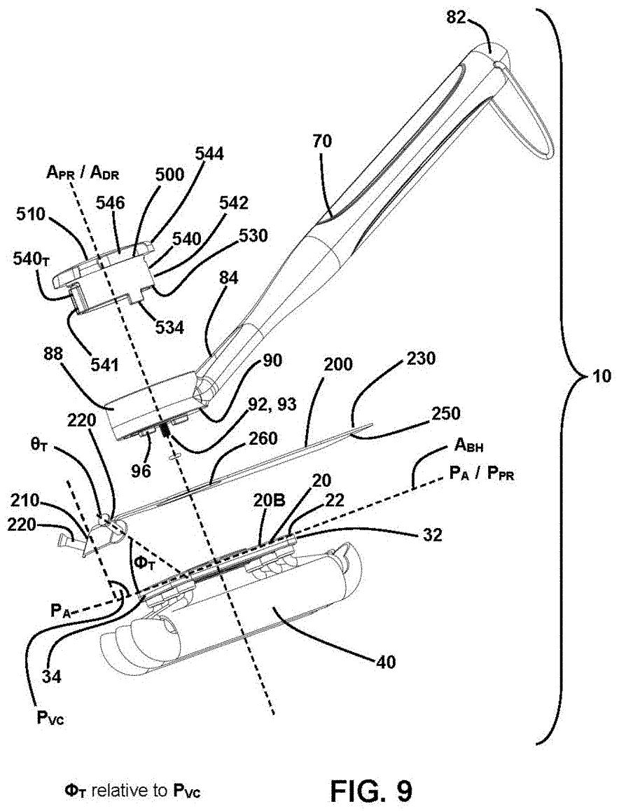

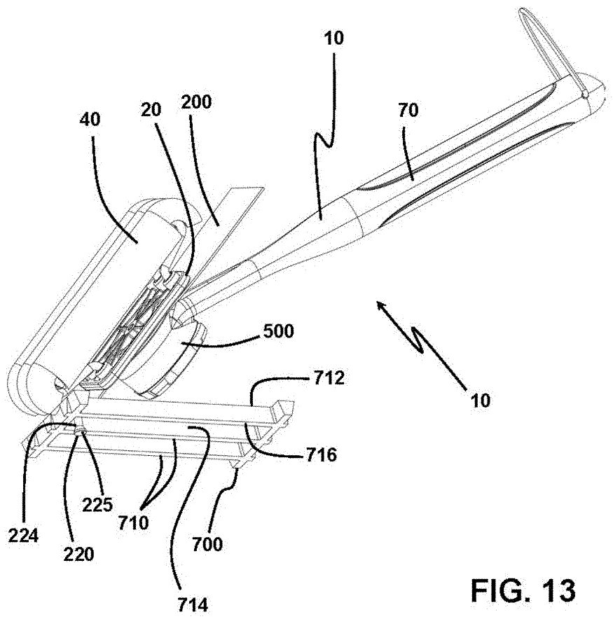

Like the version of the first embodiment shown in FIG. 1, the second illustrative embodiment includes an implement plate 200 with a plate front end 230 that terminates in a scraper blade 250. Distinguishably from the version of FIG. 1, however, in all illustrative instances depicted, the scraper blade 250 of the plate front end 230 in the second embodiment is not pitched or angled relative to the overall major lengthwise extent of the plate 200. Moreover, the plate back end 210 of the second embodiment carries tines 220 that may be like those carried by the first embodiment. However, the plate back end 210 in the second embodiment is defined in part by two laterally spaced-apart ears 212 to each of which ears 212 there is attached a tine 220. The ears 212 are angled relative to the overall major lengthwise extent of the plate 200 such that the tine 220 attached thereto is pitched at a first tine angle ϕ_{T} relative to the attachment plane P_{A}, like the tines 220 of the version of FIG. 1, as well as a second non-zero tine angle θ_{T} relative to a vertical center plane P_{VC} oriented orthogonally to the attachment plane P_{A} and including the brush-head axis A_{BH} (See exploded view of FIG. 9). Stated alternatively, the tines 220 are not only pitched relative to the attachment plane P_{A}, they diverge with respect to one another as they extend away from the implement plate 200, unlike the tines 220 of the first embodiment, which are all substantially parallel to one another. The reason for this mutual divergence of the tines 220 is more fully explained later in conjunction with FIG. 13.

The implement plate 200 is an element separate (i.e., distinct) from both the brush head 20 and the brush handle 70. Accordingly, when the brush head 20 is selectively separated from the brush handle 70, the plate 200 is freed—or can be freed—from between the brush-head upper surface 22 and the brush-head mount 88, thereby enabling replacement of the plate 200 (FIGS. 3 and 9). In the version of the plate 200 in FIG. 1, as well as the second embodiment in all illustrative instances depicted, the scraper blade 250 is an integral portion of the plate 200 as part of a unitary structure and, for this reason, the plate 200 may be referred to alternatively as a “scraper plate 200” in the specification and/or the claims.

The implement plate 200 is retained in each case—regardless of plate style—as part of the assembled grill brush 10 between the brush-head upper surface 22 and the mounting surface 90 of the brush-head mount 88. Moreover, with the brush head 20 is fixed relative to the brush handle 70, the plate 200 can be rotated about a plate-rotation axis A_{PR} between mutually opposed first and second angular orientations. Relative to the brush handle 70, the first angular orientation is such that the plate front end 230 is disposed forward of the plate rear end 210, while the second angular orientation is such that the plate front end 230 is disposed rearward of the plate rear end 210. The plate rear and front ends 210 and 230 are on opposite sides of the plate-rotation axis A_{PR}. In FIGS. 1-3, the plate 200 of the illustrative first embodiment is shown only in its first angular orientation, the second angular orientation being readily comprehensible without illustration. In FIGS. 7-9, the plate 200 of the illustrative second embodiment is shown only in its second angular orientation, the first angular orientation being readily comprehensible without illustration, particularly in light of the fact that the plate 200 of the first illustrative embodiment, while having a plate 200 of disparate configuration, it shown in its first angular orientation.

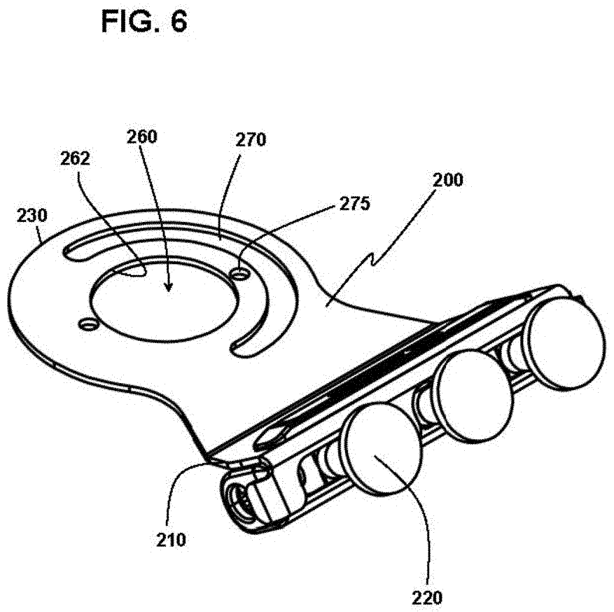

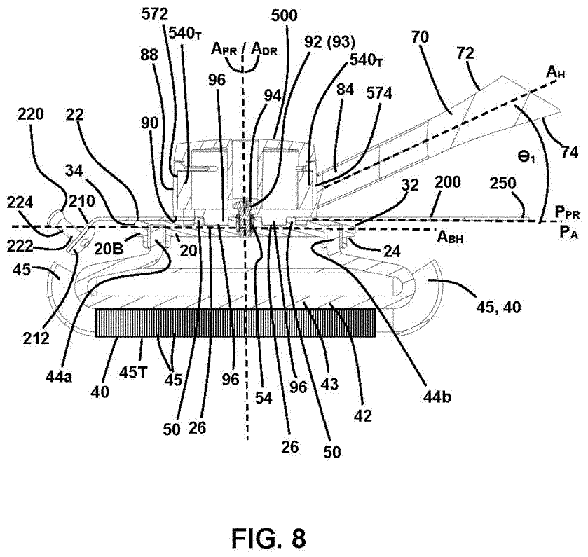

As shown in FIGS. 3 and 6 relative to the first embodiment, and FIGS. 8-10 relative to the second embodiment, the implement plate 200 has defined therethough a circular center hole 260 bounded by an annular inner edge 262. In each of the first and second embodiments, a low-profile cylindrical island 50 protrudes upwardly from, and relative to other portions of, the brush-head upper surface 22. The cylindrical island 50 is defined and bounded by an annular shoulder 52 configured for receipt into the circular center hole 260 of the plate 200. The annular shoulder 52 and annular inner edge 262 defining the center hole 260 are configured to restrict the plate 200 to rotational displacement about the cylindrical island 50. It will be readily appreciated that, when the plate 200 is mounted for rotation about the center island 50, both the center island 50 and the circular center hole 260 are centered about the plate-rotation axis A_{PR}. The cylindrical island 50 and center hole 260 essentially form a hub-and-axle relationship that facilitates rotation of the implement plate 200 about the cylindrical island 50 and the plate-rotation axis A_{PR}. FIGS. 9, 10, and 11 are particularly conducive to an understanding of this mechanical relationship. FIG. 9 is an exploded view of the second embodiment showing the brush handle 70, implement plate 200, and brush head 20 separated from one another, but aligned along the plate-rotation axis A_{PR} as they are when assembled. In FIG. 10, the brush head 20 of the second embodiment is shown in isolation while, in FIG. 11, the brush head 20 of FIG. 10 is shown with an implement plate 200 rotatably mounted thereon as it is when the grill brush 10 is fully assembled.

As the plate 200 is angularly displaced between the first and second angular orientations, the plate 200 rotates—while retained between the brush handle 70 and brush head 20—along a plate rotation plane P_{PR} relative to which the plate-rotation axis A_{PR} extends perpendicularly. The plate rotation plane P_{PR} is one of (i) parallel to and (ii) identical with the attachment plane P_{A}. In each of various embodiments, the rotatability of the plate 200 serves purposes later explained.

As previously indicated in the summary, once fastened to the brush-head mount 88, the brush head 20 remains at a fixed angular orientation relative to the handle 70. In the embodiment depicted in FIGS. 1-3, and seen best in the assembled cross-sectional view of FIG. 2, the brush head 20 is retained to the brush-head mount 88 of the handle 70 by a brush-head fastener 92. An analogous view of the second embodiment is shown in FIG. 8. The brush-head fastener 92 is held captive in the assembled handle 70 and accessible from above the brush-head mount 88 to enable selective detachment of the brush head 20 from the handle 70. Illustratively, the brush-head fastener 92 is an externally threaded fastener 93 with a keyed head 94 that facilitates rotation thereof by a complementarily-keyed tool such as a screwdriver. In the embodiments depicted, the brush head 20 is retained to the handle 70 by a single brush-head fastener 92 centrally located along the plate-rotation axis A_{PR}, but alternative locations and fastener types are, or course, within the scope and contemplation of the invention. FIGS. 8, 10, and 11 provide clear views of the internally threaded hole 54 defined within cylindrical island 50 for threadably receiving the brush-head fastener 92.

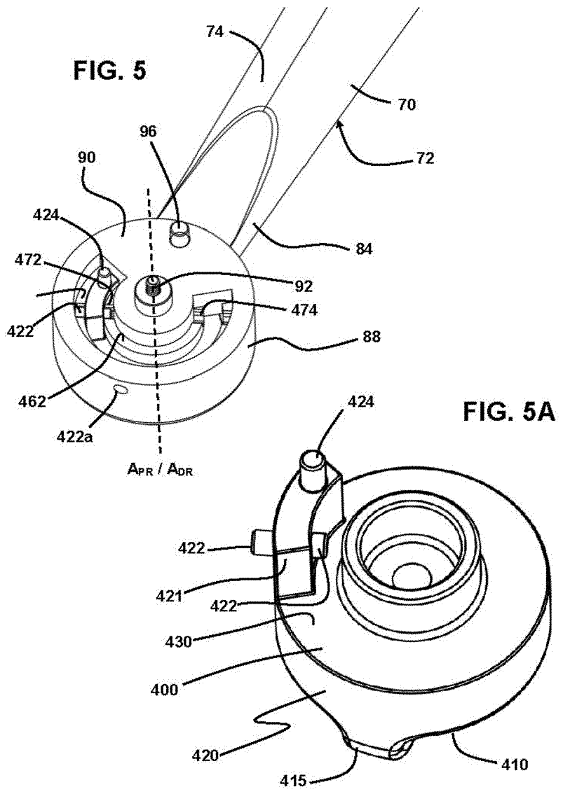

In order to prevent the rotation of the brush head 20 relative to the handle 70 as the plate 200 is rotated, there is provided at least one off-center lug 96 that mechanically connects, and establishes mechanical interference between, the brush-head mount 88 and the brush head 20. Illustratively, in the first embodiment, each off-center lug 96 is in the form of a pin or rod that extends into and between each of the brush-head mount 88 and the brush-head block 20, such as in FIGS. 2 and 5. Alternatively, the off-center lug 96 could be integrally formed (e.g., molded) with one of the brush-head mount 88 and the brush-head block 20B and received into a lug-receiving recess 26 defined in the other of the brush-head block 20B and the brush-head mount 88, as in shown most clearly in FIGS. 8-11 of the second embodiment. Regardless of the lug configuration, it is important to various versions that the lug(s) 96 and lug-receiving recess(es) 26 facilitate selective separation of the brush head 20 from the brush-head mount 88.

Among other advantages, removability of the brush head 20 facilities reversal of a brush head 20 on the brush-head mount 88. As shown in FIGS. 2 and 3, as well as FIGS. 8, 10 and 11, the brush-head upper surface 22 has defined therein two lug-receiving recesses 26 on opposite sides of the plate-rotation axis A_{PR}, with the plate-rotation axis A_{PR} situated mid-way between the lug-receiving recesses 26. This arrangement allows the brush head 20 to be removed from the brush-head mount 88, reversed, and then reinstalled and refastened onto the brush-head mount 88. In the two alternative orientations of the brush head 20, each off-center lug 96 protruding downwardly from the mounting surface 90 of the brush-head mount 88 is received into the opposite lug-receiving recess 26.

In addition to being off center of the plate-rotation axis A_{PR}, in at least the first embodiment, the off-center lug 96 extends through the plate 200. In order to facilitate plate rotation unimpeded by the off-center lug 96, there is defined through the plate 200 of the first embodiment an arcuate lug slot 270 radially displaced from, and centered about, the plate-rotation axis A_{PR} and the center hole 260. As the plate 200 is rotated, the off-center lug 96 travels within the arcuate lug slot 270. See FIGS. 3, 5 and 6. The arcuate lug slot 270 defines a circular arc that subtends an angle sufficiently large to accommodate plate rotation of at least 180°. In this way, the plate 200 can be alternatively positioned into first and second angular orientations that are 180° in opposition. Note that first embodiment requires the arcuate lug slot 270 because the off-center lug 96 passes through the implement plate 200 radially to the outside of the circular center hole 260 relative to the plate-rotation axis A_{PR}. In the second embodiment, however, each off-center lug 96 extends downwardly from the mounting surface 90 of the brush-head mount 88 into a lug-receiving recess 26 defined within the cylindrical island 50 defined on the brush-head upper surface 22. Because the cylindrical island 50 is within the annular inner edge 262 defining the center hole 260 in the plate 200, there is no need for an arcuate slot 270.

In applicable embodiments, the rotation of the implement plate 200 about the plate-rotation axis A_{PR} changes the relative positons of the scraper blade 250 and the tines 220 in order to facilitate their alternative use in disparate grill cleaning functions. More generally, the rotation changes the relative positions of the plate back and front ends 210 and 230. For instance, when the implement plate 200 is in the first angular orientation with the plate front end 230 situated forward of the plate back end 210, the scraper blade 250 is also situated forward of the tines 220. Conversely, when the plate 200 is in the second angular orientation with the plate back end 210 forward of the plate front end 230, the tines 220 are also forward of the scraper blade 250. Relative to each of the scraper blade 250 and the tines 220, the angular orientation in which it/they are forward of the other is regarded as the “deployed orientation,” while the opposite orientation is regarded as the “non-deployed orientation.” In all instances, unless otherwise noted, the relative terms “rearward of” and “forward of” are defined with respect to a user of the grill brush 10 but also, in more “self-contained” and universally applicable terms, with reference to the handle proximate end 82, which is always regarded as rearward of the brush head 20, irrespective of how a user is holding the grill brush 10 at any given time.

In order to use either one of the scraper blade 250 and the tines 220 in its deployed orientation to engage a grill surface to be cleaned, the brush handle 70 is inverted such that the brush head 20 is above the plate 200, and the bristles 45 of the bristle array 40 are facing upwardly from—rather than downwardly toward—a grill grate to be cleaned. Although depicted in relation to a grill brush 10 of the second embodiment, an illustrative section of a grill grate 700 is shown in FIG. 13 will assist in visualizing aspects of this discussion relative to both illustrative embodiments. When the scraper 250 is in its deployed orientation, it can be used to scrape grease, burned food, and other debris from the top surfaces 712 of the mutually parallel grill-grate bars 710 of the grill grate 700, as well as other surfaces within the firebox (not shown) of a grill. The tines 220, on the other hand, can be deployed to access and remove debris from the sides 714 of the grill-grate bars 710, areas that would otherwise be inaccessible to the bristles of a conventional grill brush. Moreover, both embodiments depict specially-configured tines 220, each with a tine tip 225 enlarged in cross-section relative to the tine shank 224. The purpose and advantageous of this tine configuration is discussed with principal reference to FIG. 13, but also to FIG. 11.

The tines 220 shown in association with the second embodiment do not include bristles; they are rigid structures fabricated from a durable material such as high-temperature polymeric material or metal. In one version, the tines 220 are stainless steel. In addition to the outward mutual divergence of the tines 220 previously discussed, each tine 220 includes a rigid tine shank 224 that, in the versions depicted, is substantially cylindrical. Each tine tip 225 increases in diameter as a function of increased distance from the tine base 222. Accordingly, as depicted, each tine tip 225 is substantially conical. As shown in FIG. 13, whereas a tine shank 224 may be used to run along and clean the sides 714 of grill-grate bars 710, the grill brush 10 may be tilted while inverted, as in FIG. 13, to cause an enlarged—in this case, conical—tine tip 225 to run along and remove debris from the bottom surfaces 716 (undersides) of the grill-grate bars 710. It will be appreciated that the mutual divergence of the tines 220 facilitates the insertion between grill-grate bars 710 of a single tine 220 at time, rendering the spacing between tines 220 and grill-grate bars 710 irrelevant. The inclusion of a tine 220 laterally disposed in each side of the implement plate 200 facilitates versatility, particularly relative to grill-grate bars 710 situated at the extreme right and left sides of the a grill firebox, for which oppositely-directed brush tilting and opposite tines 220 would be used.

As mentioned in the summary, in a broad aspect, the implement plate 200 could be rotated by direct contact between a user's fingers and the plate 200. However, each of various embodiments includes mechanisms for rotating the plate 200 from above the brush-head mount 88. Illustratively, these mechanisms include a rotary dial that is carried by and within the brush-head mount 88 of the handle 70. Of course, embodiments including rotary dials could be variously configured. While each of the first and second illustrative embodiments includes a rotary dial, these dials and some of their specific functionalities differ. Accordingly, the specific mechanisms for rotating the implement plate 200 of each of the first and second embodiments are separately treated. Moreover, while the rotary dials of the two illustrative embodiments have several portions and components is common, disparate series of reference numbers are used to refer to these components to reduce the potential for confusion. More specifically, for the most part, components associated with the rotary dial of the first embodiment are referenced by numbers in the 400s, while components associated with the rotary dial of the second embodiment are referenced by numbers in the 500s.

### Mechanisms for Rotating the Implement Plate of the First Embodiment

Relative to the first embodiment, mechanisms for selectively rotating the implement plate 200 from above the brush-head mount 88 are discussed with initial reference to FIGS. 1-3, and additional reference to FIGS. 4-6. As shown in various drawings, a rotary dial 400 is carried by the brush-head mount 88 of the handle distal end 84. The rotary dial 400 has dial upper and lower surfaces 410 and 430, the upper surface 410 including a fin 415 accessible to fingers of a user from above the brush-head mount 88. As shown perhaps most clearly in the exploded view of FIG. 4, he rotary dial 400 is rotatable within a dial-retaining channel 460 defined within the brush-head mount 88 by a generally cylindrical channel wall 465, in a manner and under conditions described below, in order to facilitate the rotation of the implement plate 200 between mutually opposed first and second angular orientations, such as those angular orientations previously described. The rotary dial 400 is rotatable about a dial-rotation axis A_{DR} that coincides with the plate-rotation axis A_{PR}. In addition to being rotatable within the dial-retaining channel 460 under certain conditions, the rotary dial 400 is also—when in certain angular positions—linearly reciprocable within the dial-retaining channel 460 along the dial-rotation axis A_{DR} and between mutually opposed locked and unlocked positions.

With reference to FIGS. 2 and 4, the dial-retaining channel 460 accommodates the linear displacement of the rotary dial 400 “upward” and “downward” respectively away from and toward the brush head 20 situated below the brush-head mount 88. The rotary dial 400 has an annular dial periphery 420 along which there is defined a projecting portion 421 that extends downwardly from the dial lower surface 430. Extending radially inward—orthogonally to the dial-rotation axis A_{DR}—from the projecting portion 421 is a lock protuberance 422. The lock protuberance 422 in this case is a pin 422p that, during fabrication of the grill brush 10, is inserted through a pin aperture 422a defined through the brush-head mount 88 and into the projecting portion 421 of the rotary dial 400. The pin 422p constituting the lock protuberance 422 is inserted all the way through a side wall 88_{SW} of the brush-head mount 88 and into the projecting portion 421 of the rotary dial 400 to a depth sufficient to allow the rotatory dial 400 to rotate within the brush-head mount 88.

The installed lock protuberance 422 serves two purposes discussed with principal reference to FIGS. 5 and 5A. A first purpose is to retain the rotary dial 400 within the brush-head mount 88 by extending under an annular inner step 462 defined within the dial-retaining channel 460. Without the lock protuberance 422 installed, the rotary dial 400 is free to fall out of the top side of the brush-head mount 88. As the rotary dial 400 is rotated within the dial-retaining channel 460, the lock protuberance 422 rides along the annular inner step 462, thereby retaining the rotary dial 400 within the dial-retaining channel 460. A second purpose of the lock protuberance 422 relates to defining “locked” positions of the rotary dial 400 corresponding to the first and second angular orientations of the implement plate 200.

The brush-head mount 88 has defined therein at least first and second protuberance-receiving recesses 472 and 474 diametrically opposed on opposite sides of the plate-rotation and dial rotation axes A_{PR} and A_{DR}. In the illustrative embodiment depicted, and most particularly in FIG. 5, first and second protuberance-receiving recesses 472 and 474 are defined along the annular inner step 462. A locked position of the rotary dial 400 is an “upward” position thereof in which the lock protuberance 422 is received within one of the first and second protuberance-receiving recesses 472 and 474. In a locked position, the lock protuberance 422 is in an interference fit with one of the first and second protuberance-receiving recesses 472 and 474 in order to prevent—or at least provide resistance against—unintentional rotation of the rotary dial 400. Conversely, an unlocked position of the rotary dial 400 is a “downward” position in which the lock protuberance 422 is out of interference fit with both of the first and second protuberance-receiving recesses 472 and 474 in order to permit desired rotation of the rotary dial 400. The rotary dial 400 is mechanically linked to the implement plate 200 such that, as the rotary dial 400 is rotated about the dial-rotation axis A_{DR}, the implement plate 200 rotates in unison therewith about the plate-rotation axis A_{PR}. As shown in FIGS. 5, 5A and 6, a plate-rotation lug 424 extends downwardly from the projecting portion 421 of the rotary dial 400 and extends into a rotation-lug aperture 275 in the plate 200, thereby establishing a mechanical link between the rotary dial 400 and the plate 200 by virtue of an interference fit.

The rotary dial 400 is normally biased toward a locked position. The mechanical biasing action in the present version of the first embodiment is achieved by a biasing member 435. The illustrative biasing member 435 shown in FIGS. 2 and 4 is in the form of a coiled spring 435_{CS} carried within the brush-head mount 88 and helically disposed about the plate-rotation axis A_{PR}. The biasing member 425 acts to mechanically bias the rotary dial 400 upwardly from below the rotary dial upper surface 410.

### Mechanisms for Rotating the Implement Plate of the Second Embodiment

As previously mentioned, there are similarities between the plate-rotation mechanisms of the first and second embodiments. Accordingly, because the discussion of these mechanisms relative to each embodiment is for the most part self-contained, there may be, in this regard, some redundancy in the discussion of the second embodiment relative to the first embodiment.

Relative to the second embodiment, mechanisms for selectively rotating the implement plate 200 from above the brush-head mount 88 are discussed with varying reference to all of the drawings depicting the second embodiment, beginning with FIG. 7. As shown in various drawings, a rotary dial 500 is carried by the brush-head mount 88 of the handle distal end 84. The rotary dial 500 has dial upper and lower surfaces 510 and 530. Extending between the dial upper and lower surfaces 510 and 530 is a dial side wall 540 that defines a generally cylindrical barrel 542. Atop the barrel 542 is knob portion 544 enlarged and outwardly flanged relative to the barrel 542, and including peripherally-disposed undulations 546 configured to enhance the grip of a user applying torque to rotate the rotary dial 500.

The rotary dial 500 is rotatable within a dial-retaining channel 560 defined within the brush-head mount 88, in a manner and under conditions described below, in order to facilitate the rotation of the implement plate 200 between mutually opposed first and second angular orientations, such as those angular orientations previously described. The dial-retaining channel is defined by a cylindrical channel surface 562 and a bottom channel surface 564, the channel bottom surface 564 being opposite the mounting surface 90 of the brush-head mount 88. The rotary dial 500 is rotatable about a dial-rotation axis A_{DR} that coincides with the plate-rotation axis A_{PR}. Defined through the portion of the brush-head mount 88 including, on the interior, the bottom channel surface 564 and, on the exterior, the mounting surface 90 is an arcuate lug slot 566, the purpose of which will later be explained. Unlike the rotary dial 400 of the first embodiment, the rotary dial 500 is not configured and retained for linear reciprocation within the dial-retaining channel 560, but is restricted to rotary motion about the dial-rotation axis A_{DR}.

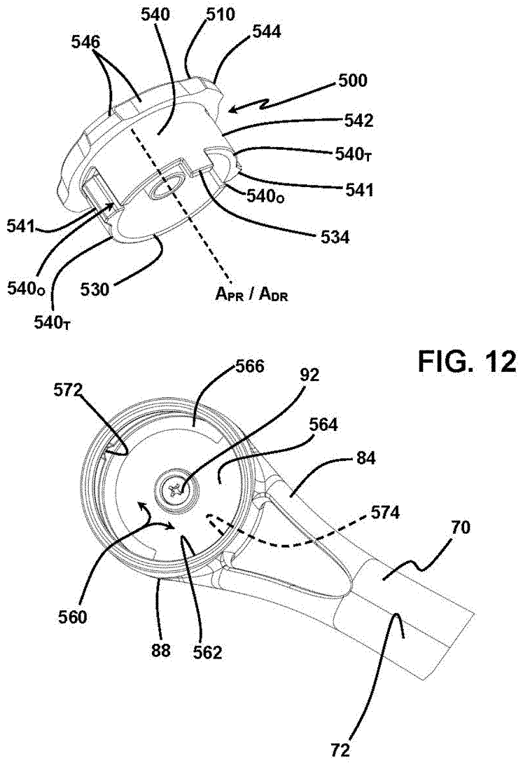

Referring primarily to FIG. 12, and secondarily to FIG. 9, at least the barrel 542 of the rotary dial 500 is fabricated form a rigid, but resilient material that exhibits a memory property such that, when it flexed under a deformation force, it returns to an original, non-flexed shape when the deformation force is removed. As seen in the top portion of FIG. 12, the dial side wall 540 includes at least one (two, in this case) side-wall opening 540_{O} that extends generally along the dial-rotation axis A_{DR}. Each side-wall opening 540_{O} defines an arcuate flexible tab 540_{T} comprised of the rigid but resilient material from which the dial side wall 540 is fabricated. Each flexible tab 540_{T} includes a lock protuberance 541 that, when the flexible tab 540_{T} in a default non-flexed state, protrudes radially outward beyond the general counter and radius of the overall side wall 540 of the barrel 542.

Referring to the lower portion of the FIG. 12, cylindrical channel surface 562 has defined therein a first protuberance-receiving recess 572. A second protuberance-receiving recess 574 is not visible in FIG. 12, but its position is indicated by a dashed lead line. Additionally, both the first and second protuberance-receiving recess 572 and 574 are visible in the cross-sectional assembled view of FIG. 7. The first and second is protuberance-receiving recesses 572 and 574 diametrically opposed on opposite sides of the plate-rotation and dial rotation axes A_{PR} and A_{DR}.

The rotary dial 500 and the dial-retaining channel 560 are cooperatively configured such that the rotary dial 500 snaps into place within the dial-retaining channel 560. Moreover, when a lock protuberance 541 is aligned with first and second protuberance-receiving recesses 572 and 574, and the flexible tab 540_{T} in a default non-flexed state, that lock protuberance 541 occupies (protrudes into) whichever of the first and second protuberance-receiving recesses 572 and 574 with which it is aligned. When rotation of the rotary dial 500 out of a locked position is desired, a user must apply sufficient torque to cause each flexible tab 540_{T} to flex radially inwardly toward the dial-rotation axis A_{DR} by an amount sufficient to free the lock protuberance 541 from the first or second protuberance-receiving recess 572 and 574 with which it is aligned. As the rotation of the rotary dial 500 continues, the lock protuberance 541 rides along the cylindrical channel surface 562 until it is aligned with the opposite one of the first and second protuberance-receiving recess 572 and 574 from which it was freed. Once this alignment occurs, the lock protuberance 541 will snap into place in the first or second protuberance-receiving recess 572 and 574 with which it is now aligned as the deformation force imparted by rotation is abated. At this point, the rotary dial 500 is locked in the opposite angular orientation.

With continued reference to FIG. 12, as previously mentioned, an arcuate lug slot 566 is defined through the lower portion of the dial-retaining channel 560. A plate-rotation lug 534 extends downwardly from the dial lower surface 530. When the rotary dial 500 is operatively seated within the dial-retaining channel 560, the plate-rotation lug 534 extends through the arcuate lug slot 566 and protrude relative to the mounting surface 90. As shown in FIG. 11, the implement plate 200 has defined therein a rotation-lug aperture 275 into which the plate-rotation lug 534 extends when the grill brush 10 is operatively assembled, thereby establishing a mechanical link between the rotary dial 500 and the plate 200 by virtue of an interference fit. It will be appreciated that the arcuate lug slot 566 and through which the plate-rotation lug 534 extends permits the rotary dial 500 and implement plate 200 to rotate between the first and second angular orientations.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A grill brush comprising:
a brush head with brush-head upper and lower surfaces, the brush-head lower surface having a plurality of bristles depending therefrom;
an elongated handle extending between handle proximate and distal ends, the handle distal being defined in part by a brush-head mount including a mounting surface configured to retain the brush-head upper surface; and
a grill-cleaning implement plate situated at least partially between the brush-head upper surface and the brush-head mount and extending between plate back and front ends, wherein
(i) at least one of the plate back and front ends has depending therefrom a grate-cleaning implement; and
(ii) the implement plate is rotatably retained between the brush-head upper surface and the brush-head mount such that, with the brush head stationary relative to the brush handle, the implement plate can be rotated with respect to the brush handle and brush head between mutually opposed first and second angular orientations.

2. The grill brush of claim 1 wherein the plate front end terminates at and defines a scraper blade.

3. The grill brush of claim 2 wherein the plate back end carries a plurality of grill-grate-abrading tines.

4. The grill brush of claim 3 wherein at least one of the tines comprises (i) a tine base by which it is retained by the plate back end, (ii) a substantially cylindrical tine shank extending away from the time base, and (iii) a substantially conical tine tip opposite the tine base that increases in diameter as a function of increased distance from the tine base.

5. The grill brush of claim 4 wherein the plurality of grill-grate-abrading tines includes two laterally spaced-apart grill-grate-abrading tines that diverge with respect to one another as they extend away from the implement plate.

6. The grill brush of claim 1 wherein the wherein the plate back end carries two laterally spaced-apart grill-grate-abrading tines that diverge with respect to one another as they extend away from the implement plate.

7. The grill brush of claim 6 wherein each of the tines comprises (i) a tine base by which it is retained by the plate back end, (ii) a substantially cylindrical tine shank extending away from the time base, and (iii) a substantially conical tine tip opposite the tine base that increases in diameter as a function of increased distance from the tine base.

8. The grill brush of claim 1 further comprising a rotary dial carried by the brush-head mount for rotation within a dial-retaining channel, the rotary dial being accessible to a user's fingers from above the brush-head mount and mechanically linked to the implement plate such that rotation of the rotary dial within the dial-retaining channel causes corresponding rotation of the implement plate relative to the brush-head mount.

9. The grill brush of claim 8 wherein the plate front end terminates at and defines a scraper blade.

10. The grill brush of claim 9 wherein the wherein the plate back end carries two laterally spaced-apart grill-grate-abrading tines that diverge with respect to one another as they extend away from the implement plate.

11. The grill brush of claim 8 wherein the plate back end carries two laterally spaced-apart grill-grate-abrading tines that diverge with respect to one another as they extend away from the implement plate.

12. The grill brush of claim 11 wherein each of the tines comprises (i) a tine base by which it is retained by the plate back end, (ii) a substantially cylindrical tine shank extending away from the time base, and (iii) a substantially conical tine tip opposite the tine base that increases in diameter as a function of increased distance from the tine base.

13. The grill brush of claim 12 wherein the plate front end terminates at and defines a scraper blade.

14. A grill brush comprising:
a brush head including a brush-head block defining brush-head upper and lower surfaces extending longitudinally along a brush-head axis between brush-head rear and forward ends;
a bristle array defined by a plurality of bristles protruding from the brush-head lower surface, each of the bristles terminating in a bristle tip for engaging a work surface;
a brush handle including a grip portion configured for grasping by a human hand and a brush-head mount, the brush handle having a lengthwise extent disposed generally along a handle axis between handle proximate and distal ends, the brush-head mount at least partially defining the handle distal end and including a mounting surface, the mounting surface and the brush-head upper surface being cooperatively configured such that (i) the brush handle can selectively capture and removably retain the brush head and (ii) when the brush head is retained by the handle, there is defined an attachment plane between the mounting surface and the brush-head upper surface; and
an implement plate at least partially situated between the brush-head upper surface and the brush-head mount and extending longitudinally along the attachment plane between plate back and front ends, wherein
(i) at least one of the plate back and front ends has depending therefrom at least one grate-cleaning implement; and
(ii) the plate is rotatably retained between the brush-head upper surface and the brush-head mount such that, with the brush head in a fixed attitude relative to the brush handle, the plate can be rotated about a plate-rotation axis, and with respect to the brush handle and brush head, between mutually opposed first and second angular orientations being respectively such that (a) the plate front end is forward of the plate back end and (b) the plate front end is rearward of the plate back end.

15. The grill brush of claim 14 wherein
(i) when retained by the brush handle, the brush head is prevented from rotating with respect to the handle by an off-center lug that (a) is situated off center of the plate-rotation axis and (b) mechanically connects, and creates mechanical interference between, the brush-head mount and the brush head;
(ii) the plate has defined therethrough and arcuate lug slot through which the off-center lug extends; and
(iii) the arcuate lug slot is centered about the rotation axis such that, as the plate is rotated, the off-center lug travels within the arcuate lug slot, thereby facilitating plate rotation, unimpeded by the off-center lug, between the first and second angular orientations.

16. The grill brush of claim 15 wherein he arcuate lug slot defines a circular arc that subtends an angle sufficiently large to accommodate plate rotation of at least 180° such that plate can be alternatively positioned into first and second angular orientations that are 180° in opposition.

17. The grill brush of claim 16 further comprising a rotary dial carried by the brush-head mount for rotation within a dial-retaining channel, the rotary dial being accessible to a user's fingers from above the brush-head mount and mechanically linked to the implement plate such that rotation of the rotary dial within the dial-retaining channel causes corresponding rotation of the implement plate relative to the brush-head mount.
